(19) United States
(12) Patent Application Publication
(10) Pub. No.: US 2012/0257969 A1
(43) Pub. Date: Oct. 11, 2012

(54) WIND POWER GENERATING SYSTEM USING TURBINE BLADES RADIALLY ARRANGED ALONG A CIRCULAR STRUCTURE

(76) Inventor: Se-Bin Kim, Chungcheongbuk-Do (KR)

(21) Appl. No.: 13/501,104

(22) PCT Filed: Oct. 11, 2010
(86) PCT No.: PCT/KR10/06940

§ 371 Date: Jun. 22, 2012

(30) Foreign Application Priority Data
Oct. 12, 2009 (KR) 10-2009-0096818

(51) Int. Cl. F03D 7/04; F03D 1/06; F03D 1/02

(52) U.S. Cl. 416/9

(57) ABSTRACT

The present invention relates to a wind power generating system using turbine blades radially arranged along a ring structure. The technical features of the present invention are for a wind power generating system in which a plurality of blades for wind power generation are radially arranged on the interior and exterior of a circular or ring structure, thereby generating wind power in an effective manner even from a weak wind, without being restricted by the area, space or the like in which the wind power generating system is installed.

### TECHNICAL FIELD

The present invention relates to a wind power generation system, and in particular to a wind power generating system using turbine blades radially arranged along a ring structure which makes it possible to more effectively generate electric power with even weak wind irrespective of an area or an installation place in such a manner that a plurality of blades designed to generate wind power are inwardly and outwardly arranged in an actiniform shape in a hoop structure.

### BACKGROUND ART

Petroleum is a consumable and depleting resource, and its supply demand sharply increases as economy develops and a low gas price continues under a situation that there is not a proper resolution for substituting petroleum. In recent years, many countries are planning strong measures for obtaining a stable energy supply resource as the dependency on petroleum deepens, so the diversifications of energy resources and energy development are being undergone in relation with energy saving and new substitute energy. Wind power seems to be the most interesting substitute energy resource. The wind power generation system generating electric power using wind is being developed while increasing the efficiency that wind is converted into energy with the aid of an advanced technology in terms of a wind power turbine design in the 1990s and advances to the extent that wind power can be generated using even weak wind. Wind is limitless and inexpensive and is not consumed and is always present in wide areas, the features of which cannot be comparable with other energy resources. The wind might be advantageously used as clean energy resource; so many countries including Korea are developing such energies together with companies and research institutes. Some conventional arts related with a wind power generation will be described below.

As a technology of generating a wind power with the aid of a rotating blade structure, there is a wind power generation system which is developed by VESTAS of Holland and is currently evaluated as one of the most advanced products. The rotor blade type wind power generation system provided by VESTAS is directed to a huge size electric power generation system which can be installed on the ground, sea or seashore or a place with a lot of wind. The rotor blade type wind power generation system is characterized in that huge wing-shaped rotor blades are coupled at a central shaft of the top of a big pillar-like tower.

According to the reports, Holland has the most advanced technologies in terms of the wind power generation field. VESTAS company belongs to Holland and is one of the representative companies in Holland. The blade type wind power generation system seems to be recognized as a basic plant facility in term of a large size project class wind power generation. There are many related information in relation with the wind power generation. In the blade type wind power generation system, at the top of the tower are provided a rotating Yaw device, and a Nacelle device which generates wind power and measures the state of wind, thus controlling the rotations of the rotor blades engaged at the central shaft at the top of the tower. The rotor blades are large sizes. Three balanced blades are formed in a rotor shape like a propeller. With the aid of the above construction, the rotor blades rotate in the direction that wind comes in under a control of the devices provided at the top of the tower and rotate on their own depending on the wind blowing in the changed direction, thus generating wind power.

As one example in terms of the conventional art related to the wind power generation, the Korean patent registration number 735581 by Wooben Arloizu of Germany discloses “A WIND FARM AND METHOD FOR OPERATING A WIND FARM”. The above conventional wind power generation system is directed to a wind power generation system and its operation method which system comprises two wind power facilities and which system and method are characterized in that the output of power of the wind power facility is limited by the levels of the maximum possible network values which are lower than the maximum possible values (rating electric power output) of the electric power in order to enhance the operation efficiency and the driving efficiency, and the maximum possible supply values are determined by the accommodation capacity (line capacity) of the network to which the energy is supplied and/or are determined by the electric power capacity of the energy transfer unit supplying the energy generated by the wind power facility or the transformer.

However, The conventional wind power generation facility is mainly based on a wind power generation technology which is generally implemented in a super large power generation system, so the size of the same is very large, and there are a lot of problems for ordinary people to use the same for generating wind power. In addition, the conventional art needs strong wind for generating a desired wind power, and ordinary people are hard to use and handle. In addition, it is urgently needed to develop a technology which helps generate electric power and help enhance the efficiency of wind power generation without using a large size power generation facility in terms of the facility or apparatus for a wind power generation.

### DISCLOSURE OF INVENTION

Accordingly, the present invention is made to resolve the problems encountered in the conventional art, and it is an object of the present invention to provide a wind power generating system using turbine blades radially arranged along a ring structure which is characterized in that it is possible to more effectively generate electric power with weak wind in such a manner that a plurality of blades designed to generate wind power are inwardly and outwardly arranged in an actiniform shape or in a circular or ring shaped hoop structure.

To achieve the above objects, there is provided a wind power generating system using turbine blades radially arranged along a ring structure which comprises a control hub module which is extended in a forward direction of a central shaft of the support structure from the top of the support structure and is assembled and engaged and serves to control the pitch angles of a plurality of blades forming the wind power generation system depending on the speed of wind; an inner blade module which causes rotations at a central portion by means of the wind blowing toward the inner side of the wind power generation system and in which an inner central portion is engaged with the control hub module so that it operates in accordance with a control of the control hub module, and is formed by a certain length in an equally divided actiniform shape from the center of the control hub module; a link module of which one end is assembled and engaged to an end portion of the inner blade module, and the other end is assembled and engaged to the outer blade module, so that the pitch angles can rotate depending on the rotation operation of the inner blade module; a hoop module which is formed in a circular hoop shape with a certain width in a state that the end portion of the inner blade module is fixed toward the outside of the inner blade module; and an outer blade module which causes rotations by means of wind blowing toward the outside of the wind power generation system and is formed in an actiniform shape by a certain length toward the outside of the hoop module in a state that an end portion of each one side is engaged in an outward direction of the hoop module, whereby the pitch angles of the inner blade module and the outer blade module are control-rotated depending on the speed of wind, and the pitch angles based on the change of the speed of wind are adjusted, thus generating wind power.

### ADVANTAGEOUS EFFECTS

The wind power generating system using turbine blades radially arranged along a ring structure according to the present invention is characterized in that it can efficiently operate at a low wind speed, and the size of the wind power generation system can be made smaller, and the output of the wind power can be increased by adding the blades in the wind power generator with the same size, and it is possible to generate larger output for the size of the facility. Since the lengths of the blades can be made shorter, so the manufacture costs can be saved.

### BRIEF DESCRIPTION OF DRAWINGS

FIG. 1 is a perspective view illustrating a wind power system according to an embodiment of the present invention.

FIG. 2 is a front and plane view illustrating a wind power system of FIG. 1.

FIG. 3 is a view for explaining the operation of a wind power of a tower module coupled to the construction of FIG. 1.

FIG. 4 is a view for explaining a control hub module of FIG. 1.

FIG. 5 is a view for explaining a structure of major engaging parts of FIG. 1.

FIGS. 6 and 7 are views illustrating an engaging construction of inner and outer blade modules of FIG. 1.

FIG. 8 is a view for explaining an engagement of a link module of FIG. 1.

FIG. 9 is a view illustrating an engaging construction of a hoop module and an outer blade module of FIG. 1.

FIG. 10 is a view for explaining a blade structure which operates as a wing part adapted to the construction of FIG. 1.

FIG. 11 is a view illustrating an engagement relationship about a hoop module of FIG. 1.

FIG. 12 is a perspective view illustrating another embodiment of FIG. 1.

<Descriptions of reference numerals of major elements in the drawing>

10: a wind power generating system using turbine blades radially arranged
along a ring structure

| | | |
|---|---|---|
| 10T: tower module | 110: control hub module | 120: inner blade module |
| 130: link module | 140: hoop module | 150: outer blade module |

### MODES FOR CARRYING OUT THE INVENTION

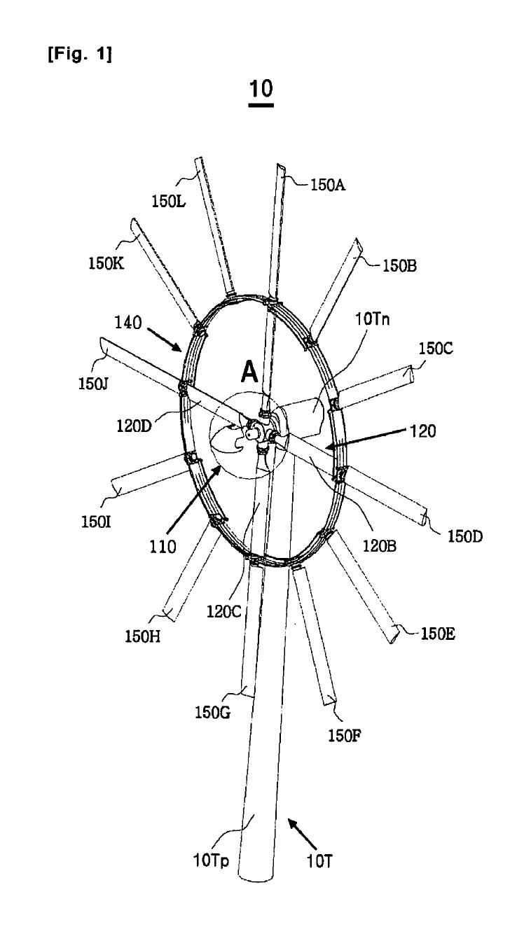

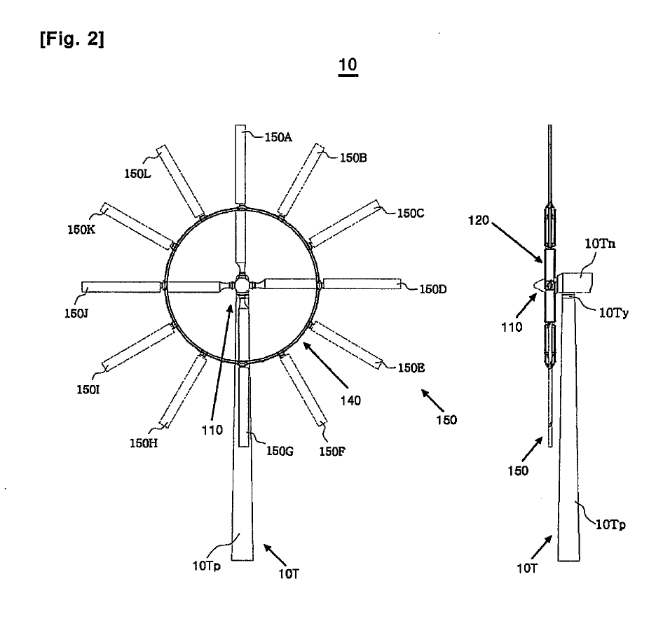

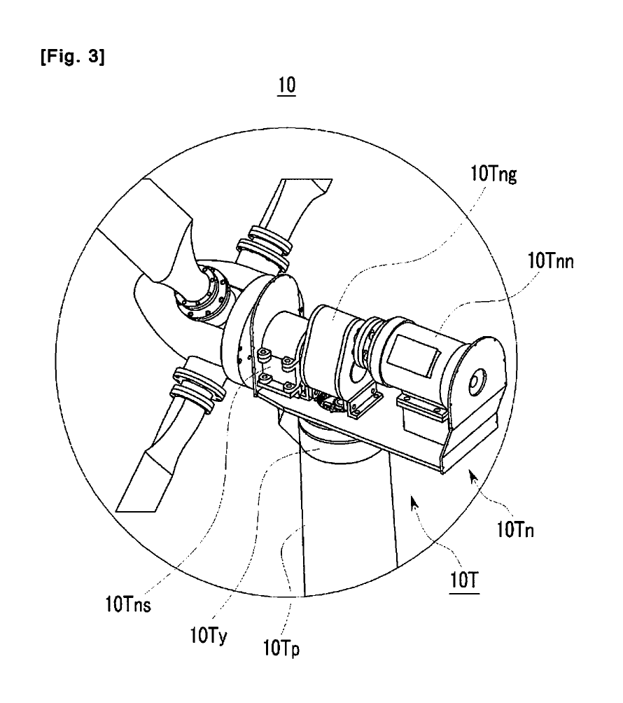

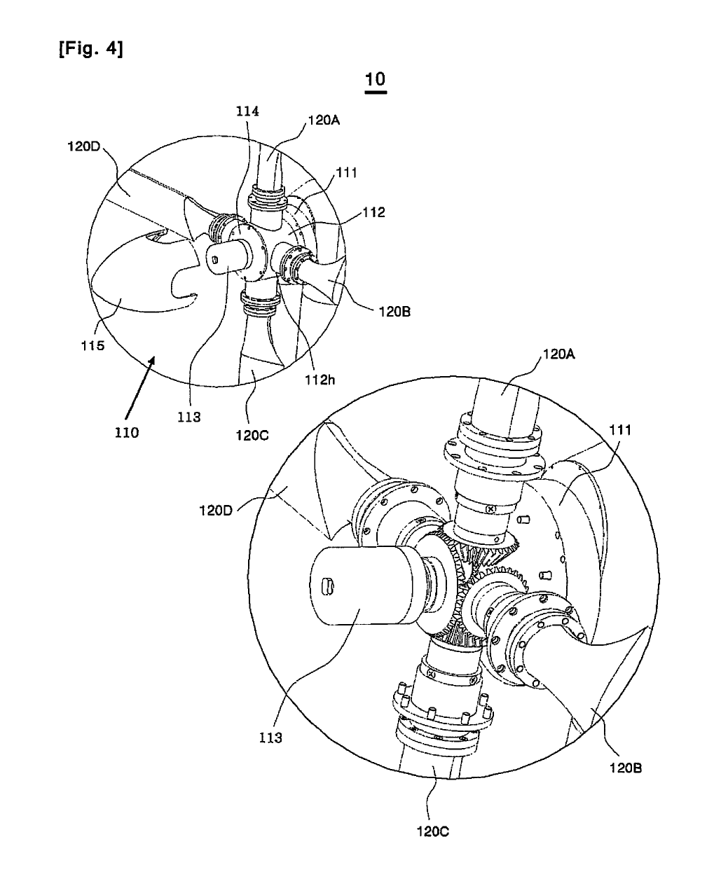

The wind power generating system using turbine blades radially arranged along a ring structure according to the present invention will be described with reference to the accompanying drawings. FIG. 1 is a perspective view illustrating a wind power system according to an embodiment of the present invention. FIG. 2 is a front and plane view illustrating a wind power system of FIG. 1. In addition, FIG. 3 is a view for explaining a wind power generation in a tower module engaged to a wind power generating system using turbine blades radially arranged along a ring structure of FIG. 1. FIG. 4 is a view for explaining a control hub module of a wind power generating system using turbine blades radially arranged along a ring structure of FIG. 1 in which (a) shows an outer construction, and (b) shows an inner construction.

As shown in therein, the turbine blade wind power system 10 according to the present invention comprises a control hub module 110, an inner blade module 120, a link module 130, a hoop module 140 and an outer blade module 150. The tower module 10T is generally used as a support structure, but a modified structure might be adapted, thus forming one system.

The tower module 10T, which operates as a basis support, is directed to a construction part which is formed in a pillar shape and is rotatably supported at a certain height, thus generating wind power in a state that it is controlled depending on the direction and speed of wind blowing. The tower module 10T comprises a tower post 10Tp, a Yaw device 10Ty and a Nacelle device 10Tn.

The tower post 10Tp servers to support as a pillar the wind power generating system using turbine blades radially arranged along a ring structure. The wind power generating system using turbine blades radially arranged along a ring structure 10 might have over 10 m of the diameter of the hoop actiniform turbine blade or might have about 1 m of the diameter of the same. Each size is determined under the given situation. In each case, the tower post 10Tp serves stably support the whole construction of the wind power system 10. In terms of the tower module 10T, the Yaw device 10Ty is generally positioned at the top, and the Yaw device 10Ty belongs to the constructional part which rotates the wind power generating system using turbine blades radially arranged along a ring structure depending on the direction of wind. In the wind power generating system 10 using turbine blades radially arranged along a ring structure, the rotation is performed depending on the direction of wind, and the pitch angle is controlled depending on the speed of wind, thus generating wind power. The Yaw device 10Ty is directed to a construction which causes rotations depending on the angle of wind direction, namely, the angle that wind blows with the aid of motor or a construction that gears are engaged.

At the top of the Yaw device 10Ty is provided the Nacelle device 10Tn. Here, the Nacelle device 10Tn is directed to a space of one control and adjustment device. The Nacelle device 10Tn comprises a support device 10Tns, a gearbox 10Tng, a power generator 10Tnn, etc. There might be provided a meter for measuring the direction or speed of wind and a regulator 10Tna adjusting an inner blade module 120 and an outer blade module 150 with a pitch rotation angle or something depending on the speed of wind. All the necessary inner elements are mounted in the Nacelle device 10Tn, and then an external cover is covered, thus completing the Nacelle device 10Tn. The electric power is generated as wind power is generated via the Nacelle device 10Tn. In recent years, as technologies advance, anemoscope measuring the direction of wind or anemometer measuring the speed of wind both of which are implemented using an electronic, digital or ultrasonic way might be installed at an outer side of the Nacelle device 10Tn.

In the wind power generating system 10 using turbine blades radially arranged along a ring structure according to an embodiment of the present invention, a control hub module 110 is engaged to a front side of the tower module 10T. The control hub module 110 according to an embodiment of the present invention is extended toward a central shaft, which is adapted for a wind power generation, from the top of the tower module 10T, so it causes rotations by controlling the pitch angle of a plurality of the blades forming the wind power generation system 10 depending on the speed of the wind blowing toward the wind power generation system 10, and the control hub module 110 comprises a hub base 111, a hub bracket 112, a control motor 113, a bracket cover 114 and a hub cover 115.

In the embodiment of the present invention, the hub base 111 is formed in a circular shape to support the force generating during the wind power generation by the wind coming in and the rotation control of the control hub module 110. To the hub base 111 are assembled a hub bracket 112, a control motor 113, a bracket cover 114 and a hub cover 115 which all belong to the control hub module 110. Since it is stable fixed passing through the support part 10Tns positioned at a front side of the Nacelle device 10Tn of the tower module 10T, so it is possible to support a large force.

At a front side of the hub base 111 is coupled a hub bracket 112. As shown in the drawing, the hub bracket 112 is formed in a cylindrical shape in whole and has a bracket hole 112h along an outer circumferential surface of the cylindrical construction, thus engaging the inner blades 120A to 120D of the inner blade module 120 in the inserted states. As shown in the drawing, the inner blade module 120 is formed by means of four inner blades 120A to 120D in the embodiment of the present invention, and four bracket holes 112h are formed at the hub bracket 112 while matching with the number of the inner blades 120A to 120D.

There is provided a stepping type control motor 113 as one element of the major construction parts of the control hub module 110 in the embodiment of the present invention. As shown in the drawings, gears are formed at the end coming into contact with the inner blades 120A to 120D in terms of the control motor 113 of the embodiment of the present invention, with the aid of which construction it is possible to control the pitch angles of the inner blades 120A to 120D in response to a control from the control hub module 110. In the embodiment of the present invention, the gears are formed in bevel gear shapes. With the aid of the earlier constructions, the control moor 113 controls the pitch angles of the inner blades 120A to 120D of the inner blade module 120.

As earlier described, the wind power generating system 10 using turbine blades radially arranged along a ring structure in the embodiment of the present invention is controlled depending on the direction and speed of wind. In the worst case in which the speed of the wind, which is the intensity of the wind, becomes multiple times stronger than the normal situations, for example, when the speed of wind is 30 m/sec, 40 m/sec, etc., wind power generation cannot be performed normally. In this case, the pitch angle of each hoop actiniform turbine blade of the inner blade module 120 and the outer blade module 150 is adjusted to be the same direction as the flow of the wind for a stable wind power generation and its safety, so it is controlled that the rotations of the wind power generation system are stopped so as to prevent the damages of each constructional element which operates at a high speed due to the strong wind, thus generating a stable wind power generation. Namely, in each case depending on the intensity of wind, the signal current based on the pitch angle valve corresponding to the rotations conducted depending on the measure speed of wind is transmitted to the control motor 113, and the control motor 113 rotates as much turns as the transmitted value, so each hoop actiniform turbine blade of the inner blade module 120 and the outer blade module 150 rotates at a controlled pitch angle. The above rotation principle and structure will be described later in details. The control motor 113 passes through the bracket cover 114, and the bracket cover 114 is engaged to a front side of the hub bracket 112.

The bracket cover 114 covers one side of the cylindrical hub bracket 112 while the control motor 113 is inserted, and the end of the control motor 113 is drivingly engaged with the ends of the inner blades 120A to 120D of the inserted inner blade module 120.

The operation that the control motor 113 is engaged with the inner blades 120A to 120D of the inner blade module 120 was described in the above. The operation that the control motor 113 of the embodiment of the present invention conducts controls with the aid of the above-described construction might be obtained by the structure that the bracket cover 114 is stably engaged to the hub bracket 112. In addition, the hub cover 115 is engaged to a front, outer side to which the control motor 113 is assembled and engaged.

As shown therein, the hub cover 115 of the embodiment of the present invention is formed in a concave cap shape in whole and is formed of a U-shaped curved groove like the inner blades 120A to 120D of the inner blade module 120 inserted and engaged in the hub cover 115 are interdigitated. As they are engaged like that, the hub cover 115 is assembled with the ends of the lower sides of the inner blades 120A to 120D being inserted. The control hub module 110 is like a construction positioned at the center, thus generating wind power of the wind power generating system 10 using turbine blades radially arranged along a ring structure, and the control hub module 110 is reliably assembled to the tower module 10T in such a way to stand the force generating due to wind and rotation.

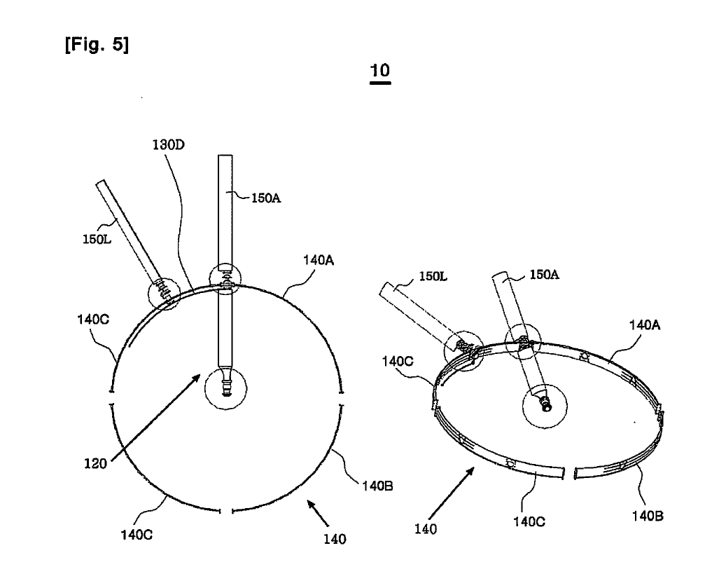

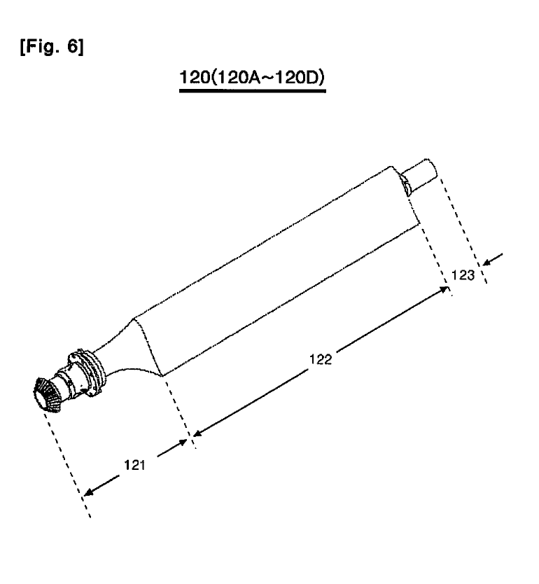

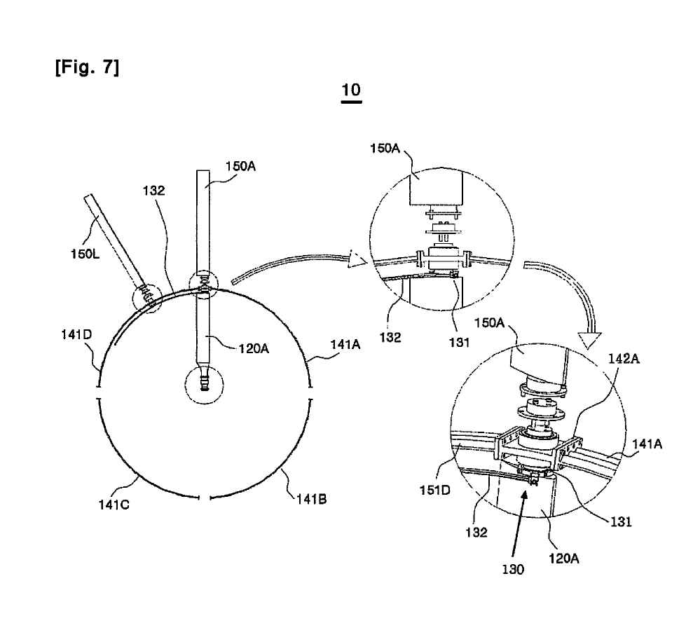

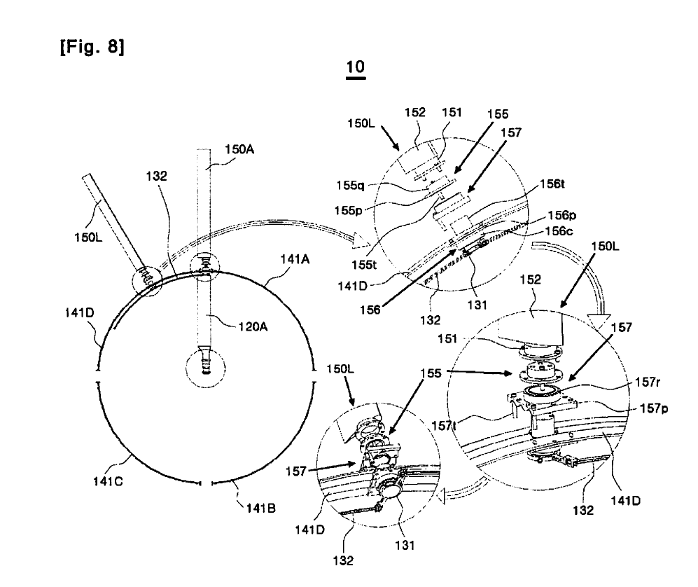

FIG. 5 is a view for schematically explaining the structure of major engaging portions in terms of the wind power generating system using turbine blades radially arranged along a ring structure of FIG. 1, and FIGS. 6 and 7 are views for explaining the engaged relationship about the inner blade module and the outer blade module in terms of the wind power generating system using turbine blades radially arranged along a ring structure of FIG. 1, and FIG. 6 is a view illustrating a structure of an inner blade module, and FIG. 7 is a view illustrating an engagement of the inner blade module and the outer blade module, and FIG. 8 is a view for explaining an engagement of the link module in terms of the wind power generating system using turbine blades radially arranged along a ring structure of FIG. 1, and FIG. 9 is a view illustrating an engagement about the hoop module and the outer blade module in terms of the wind power generating system using turbine blades radially arranged along a ring structure of FIG. 1.

In the wind power generating system 10 using turbine blades radially arranged along a ring structure according to the present invention, the inner blade module 120 assembled to the control hub module 110 is formed and extended as long as a certain length at an angle in an actiniform shape equally divided from the center of the control hub module 110 under the control of the pitch angle of the control hub module 110 and is formed like a construction that the wind power is generated by means of the wind blowing in the inward direction of the turbine blade wind power system 10. As described earlier, in the present embodiment, the inner blade module 120 is formed of four inner blades 120A to 120D which are visually recognized well. The inner blade module 120 is formed of an engaging gear part 121, a wing part 122 and an outer circumferential surface engaging part 123. In terms of the inner blade module 120 of the four inner blades 120A to 120D, the engaging gear part 121 is coupled to the control hub module 110 positioned at the center of the turbine blade wind power generation system 10. In terms of each of the inner blade 120A to 120D of the inner blade module 120, the portion coupled to the control hub module 110 corresponds to the engaging gear part 121. As shown in the drawing, the engaging gear part 121 is inserted into the hub bracket 112 of the control hub module 110 and is assembled like it is engaged with the control motor 113 of the control hub module 110. In the present embodiment, it is formed like the bevel gear. In the present embodiment, the engaging gear part 121 is formed in a slight curve shape for a connection with the wing part 122. Its construction is not limited as long as it can enhance the efficiency of the wing power generation.

Next the wing part 122 is formed in an aerodynamic wing shape and has a certain regular length and is like a construction coupled near the engaging gear part 121. Wind collides with each of the inner blade 120A to 120D of inner lade module 120 except for the engaging gear part 121, thus generating a rotational force for wind power generation.

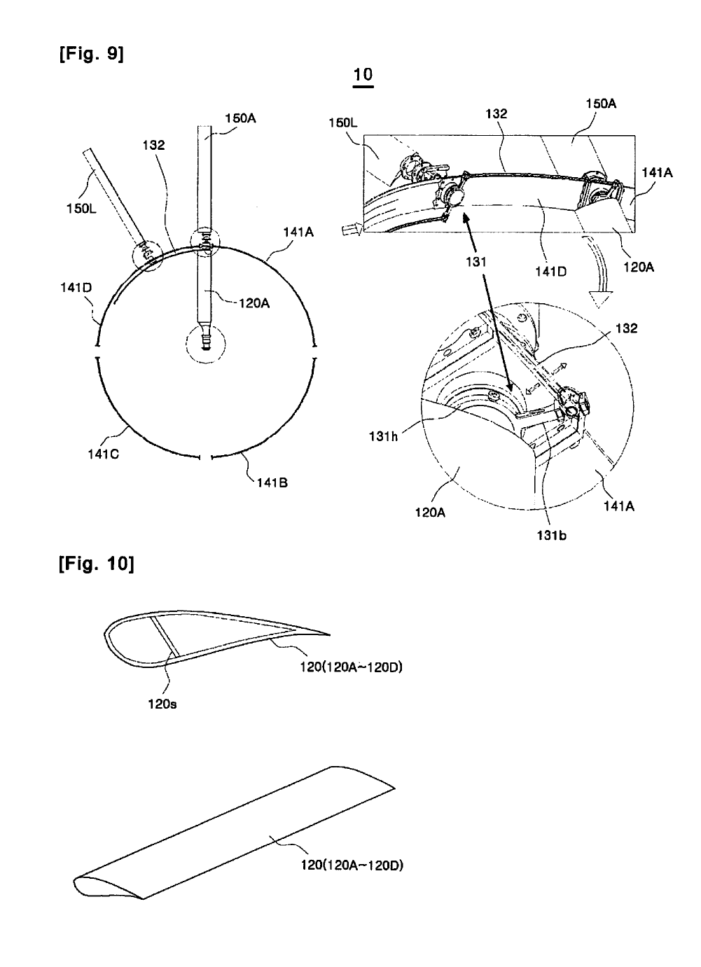

FIG. 10 is a view for explaining the blade structure as a wing part adapted to the wind power generating system 10 using turbine blades radially arranged along a ring structure of FIG. 1. As shown therein, the cross section shape of each of the inner blade 120A to 120D of the inner blade module 120 according to the present embodiment of the present invention is formed in a protruded shape like a tadpole head at its one side. In the opposite direction, the widths of the remaining portions become narrow like a tail in the direction of their rear sides, and the lower sides are shaped in whole like parabola. It is preferred that the inner side is hollow so as to decrease the weight, and it is preferred that the support parts 120s are durable in whole and are provided as many as necessary in order to stand the force at their front sides the shape of which is directed to well receiving lift. The wing part 122 of the inner blade module 120 of the present embodiment is formed in a shape helping enhance the efficiency of the wind power generation by means of the wind coming in now that wing part 122 has a high lift effect. Various blade structures might be adapted.

The outer circumferential surface engaging part 123 of the present embodiment is provided by a certain length in an outward direction of the wing part 122 and is shaped like a protruded circular pillar and has an engaging hole for an engagement in an outward direction. The outer circumferential surface engaging part 123 is a construction part which is assembled with the elements such as a link module 130, a hoop module 140 and an outer blade module 150. Next, as shown in the drawing, the link module 130 is assembled with its one end being engaged to an end portion of the inner blade module 120, with its other end being assembled to the outer blade module 150. The link module corresponds to a construction part helping transfer a rotational force based on the rotation operation of the inner blade module 120 for adjusting the pitch angle based on the wind speed in the turbine blade wind power generation system 10 of the present invention. The link module 130 is coupled to an end portion of each of the inner blades 120A to 120D of the inner blade module 120, thus transferring rotational force in order to rotate the pitch angle of each of the inner blades 120A to 120D of the inner blade module 120 and the pitch angle of each of the outer blades 150A to 150D of the inner blade module 150 as the control motor 113 starts operating.

The present embodiment of the present invention is designed so that the inner blade module 120 and the outer blade module 150 can rotate at the same angle at the same time.

In the present embodiment, the link module 130 can be classified into a link assembly part 131 and a link bar 132. The link assembly part 131 is like a construction part which is fixedly coupled to either the inner blade module 120 or the outer blade module 150, thus transferring rotational force. As shown in the drawings, the present embodiment is characterized in that a link hole 131h is formed at the center like a ring shape, and an engaging bridge 131b is formed like a branch shape at both outer ends and is coupled with an external structure such as an inner blade module 120 and a link bar 132, respectively, thus performing a function of transferring rotational force. The link bar 132 is formed in a rod-like longitudinal bar shape and is like a construction part connected to transfer the rotational force from the link assembly part 131 as it is rotatably coupled with the link assembly part 131. The link bar 132 looks like a longitudinal bar shape and can be bent like the hoop module 140, with its one end being coupled with the engaging bridge 131b of the link assembly part 131, with its other end being coupled with a lower side of the outer blade module 150 which is provided as a singular element not protruded from a portion transferring rotational force, namely, the inner blade module 120, thus transferring rotational force.

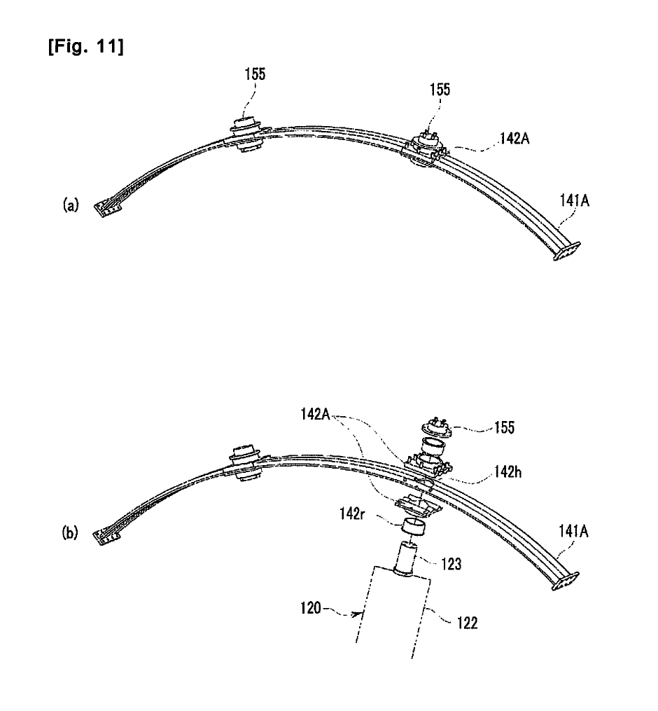

FIG. 11 is a view for explaining an engagement relationship about a hoop module in the wind power generating system using turbine blades radially arranged along a ring structure of FIG. 1, in which (a) shows an engaged state of the hoop module, and (b) shows a separated state of the hoop module. In the present embodiment the hoop module 140 is formed in a circular shape with a certain width in a state that the end portion of the inner blade module 120 is fixed in an outward direction of the inner blade module 120. The hoop module 140 is formed of partial hoop parts 141A to 141D and hoop connector parts 142A to 142D, and the hoop connector parts 142A to 142D are positioned between the partial hoop parts 141A to 141D, thus engaging the partial hoop parts 141A to 141D of both sides.

It is preferred that the partial hoop parts 141A to 141D have certain widths like the belts and are formed in wrinkled shapes in the longitudinal direction so as to reinforce the assembled strength of the whole wind power generation facility and are made from a light and durable material. The partial hoop parts 141A to 141D are formed in arc shapes at certain angles and have hoop holes 142h for their installation in an actiniform shape and are separated partially at regular portions in a four-divided shape. Each of the partial hoop parts 141A to 141D forming the hoop module 140 looks like a shape dividing the circular ring member into four parts each with a certain width like a belt. With the aid of the above construction, a plurality of partial hoop parts 141A to 141D formed by dividing into in an arc shape having a certain angle are connected and assembled, thus structurally forming the hoop module 140 according to the present embodiment. The hoop connector parts 142A to 142D of the present embodiment are like a construction coupled in such a way that the partial hoop parts 141A to 141D are positioned at both sides, and then the hoop connector parts are disposed between them. The hoop connector parts are characterized in that a hoop hole 142h is formed at a connector piece 142p of the center with a certain thickness, and the engaging terminals 142q1 and 142q engaging and connecting the partial hoop parts 141A to 141D like being attached to both sides of the connector piece 142p are formed in the directions vertical to the connector piece 142p. The hoop hole 142h of the center of the connector piece 142p is like a structurally formed space so formed that the outer blade module 150 can be rotation-controlled in the same direction as the inner blade module 120 in a state that the frame of the assembled hoop module 140 can be maintained like the hoop module 140.

In the present embodiment, a mover 142r is provided at an outer side of the outer circumferential surface engaging part 123 for a free movement of the outer blade module 150. As shown in the drawing, a mover 142r like a bearing or something so formed that the inner and outer sides can move with respect to the same is inserted and assembled in a plurality of the hoop holes 142h, so the inner blade module 120 and the outer blade module 150 can naturally operate while the hoop module 140 maintains an assembled shape as the mover 142r. Here, the bearing might be formed of a roll bearing (a roller bearing), a ball bearing, a thrust bearing, etc. and is not limited to its type and kind as long as it is designed to move to each other and operate for the same purpose. The inner blade module 120 and the outer blade module 150 can naturally operate while the hoop module 140 maintains the assembled frame with the aid of the above operation.

In the present embodiment, the inner blade module 130 is provided in four for the purpose of maintaining a stable operation by preventing distortion or twist in the structure of the wind power generation system during the actual wind power generation by combining the hoop module 150 and the outer blade module 150. The above number of four is not limited thereto, and the number can be changed if necessary. The hoop module 140 according to the present embodiment is engaged by means of the partial hoop parts 141A to 141D and is assembled and engaged in one ring shape in whole, which helps form the wind power generating system using turbine blades radially arranged along a ring structure of the present invention. In the event that the hoop module 140 is formed in one ring shape in whole, it is not needed to form in such a way that the connector piece 142p can be separated, but a hoop hole 142h is formed for the rotation operations of the inner blade module 120 and the outer blade module 150, and the mover 142r is assembled in the hoop hole 142h as described earlier.

In the wind power generating system 10 using turbine blades radially arranged along a ring structure according to the present embodiment, the outer blade module 150 is formed in an actiniform shape by means of the plurality of the outer blades 150A to 150L assembled to the inner blade module 120 or the hoop module 140 by a certain distance outside the hoop module 140. The outer blade module 150 and the inner blade module 120 have big differences in their assembling positions; however there is a lot of similar features as compared with the assembling and engaging procedures as for the inner blade module 120. The outer blade module 150 according to the present embodiment is formed of 12 outer blades 150A to 150L which are visually recognized well. The outer blade module 150 can be classified into the inner engaging part 151 and the wing part 152 unlike the inner blade module 120. In addition, the assembling type of the outer blade module 150 is classified into a case that it is assembled to the outer circumferential engaging part 123 of the inner blade module 120 and a case that it is assembled in a singular form on the hoop module 140. Both the cases will be described. There is a little difference in the constructions depending on the assembling type that the outer blade module 150 is assembled, but it might be assembled in various types by changing the elements or engaging methods.

In the present embodiment, the outer blade module 150 is formed of an inner engaging part 151 and a wing part 152 which are provided as major elements. An engaging adaptor 155, a hoop base 156 and a blade base 157 might be added and assembled to the above major elements for enhancing the durability and convenience of the assembling and engaging procedures. The inner engaging part 151 of the outer blade module 150 is formed in a cylindrical shape of the center protruded in the direction of the hoop module 140 from the outer blade module 150 and is formed of an engaging end portion coming into vertical contact with the same. The inner engaging part 151 is engaged to the outer circumferential surface engaging part 123 of the inner blade module 120 or the hoop module 140, respectively. The inner engaging part 151 of the outer blade module 150 is not a bevel gear formed at its outer end unlike the inner blade module 120. It can be engaged by using some intermediate accessory elements or instrument depending on the assembling type. The assembling procedure will be described in details later.

The wing part 152 is formed with a certain length in an aerodynamic wing shape, which was described in the inner blade module 120, and is formed like a construction that it is coupled next to coming into contact with the inner engaging part 151 of the outer blade module 150. The wing part 152 has the construction described with reference to FIG. 10 and is actually collided with wing and operates, the whole operations of which are same as descried earlier. In terms of the outer blades 150A, 150D, 150G and 150J of the present embodiment assembled and extended from the inner blade module 120 of each of the 12 outer blades 150A to 150L of the outer blade module 150, the inner engaging part 151 is formed of a ring-shaped engaging end portion 151c at the end portion protruded by a certain length from the wing part 152 and is assembled and engaged to the outer circumferential surface engaging part 123 of the inner blade module 120 by way of the engaging adaptor 155.

As shown in the drawing, the engaging adaptor 155 according to the present embodiment is characterized in that a pin protrusion 155t is protruded from its one side about the circular engaging disk 155p formed in a circular disk shape at the center and is inserted into the engaging hole formed at the inner blade module 120, and a circular pillar shaped protrusion pillar 155q is formed at the opposite portion and is inserted into the inner engaging part 151 of the cylindrical outer blade module 150 for preventing movements. As shown in the drawing, the pin protrusion 155t of the engaging adaptor 155 is fixedly inserted into the engaging hole of the inner blade module 120, and the protrusion pillar 155q of the engaging adaptor 155 is inwardly inserted into the inner engaging part 151 of the outer blade module 150, thus allowing the outer circumferential surface of the engaging circular disk 155p to come into contact with the outer circumferential surface of the inner engaging part 151, and then the engaging circular disk 155p of the engaging adaptor 155 is coupled with the inner engaging part 151 of the outer blade module 150 by way of the grooves formed at the circumferential surface of the engaging circular disk 155p, thus subsequently coupling the inner blade module 120 and the outer blade module 150.

In the present embodiment, unlike the outer blade module 150 which is assembled on the same extended line of each of the inner blade2 120A to 120D of the inner blade module 120, the hoop base 156 is coupled to the hoop module 140 for an engagements of the outer blades 150B, 150C, 150E, 150F, 150H, 150I, 150K and 150L which form the outer blade module 150 in a singular form which is not extended from the inner blade module 120, the construction of which becomes a basis for the assembling engagement.

As shown in the drawing, the hoop base 156 is characterized in that a link engaging terminal 156c is formed at one side in a pillar shape for inserting and engaging the link assembly part 131 of the link module 130 about the circular disk shaped hoop base circular disk 156p for attaching to the surface of the hoop module at its center, and a base pillar 156t protruded in a circular pillar shape is formed at the opposite side. A blade base 157 is engaged to the hoop base 156.

The blade base 157 of the present embodiment is a construction part which is assembled and engaged while coming into contact with the outer blades 150B, 150C, 150E, 150F, 150H, 150I, 150K and 150L of the outer blade module 150 assembled in a singular form and is characterized in that a protrusion shaped hoop engaging protrusion 157t is protruded from a cross section portion for inserting and engaging the hoop module 140 at one side, and a hoop engaging terminal 157r protruded in a circular pillar shape is formed at the opposite side for an engagement with the engaging adaptor 155. So, the previous hoop base 156 and the blade base 157 are selectively adapted to the engaging adaptor 155 for thereby being used to the wind power generating system using turbine blades radially arranged along a ring structure of the present embodiment. The example of the procedures that the wind power generating system 10 using turbine blades radially arranged along a ring structure according to the present embodiment is formed based on the assembling and engagement of the above elements.

A tower post 10Tp, which is the center of the tower module 10T, is installed where the wind power generating system 10 using turbine blades radially arranged along a ring structure according to the present invention is to be installed. The Yaw device 10Ty and the Nacelle device 10Tn are installed at the tower post 10Tp. The tower post 10Tp might be installed at the installation place after the Yaw device 10Ty and the Nacelle device 10Tn are previously engaged to the tower post 10Tp.

The installation of the wind power generating system using turbine blades radially arranged along a ring structure according to the present invention is completed as the control hub module 110, the inner blade module 120, the link module 130, the hoop module 140 and the outer blade module 150 are assembled to the tower module 10T. For more efficient installations, the wind power generating system 10 using turbine blades radially arranged along a ring structure according to the present invention is first assembled, and then the assembled hoop actiniform blade is assembled to the tower module 10T. The above procedure will be described.

When assembling and engaging the hoop actiniform blade according to the present embodiment, four partial hoop parts 141A to 141D and the hoop connector parts 142A to 142D are engaged, thus assembling a circular hoop module 140. The hoop base 156 is engaged to the hoop module 140 for an engagement of the outer blades 150B, 150C, 150E, 150F, 150H, 150I, 150K and 150L which belong to the outer blade module 150 formed in a singular form and not extended from the inner blade module 120, and the thusly engaged hoop base 156 becomes an assembled basis with respect to the outer blades 150B, 150C, 150E, 150F, 150H, 150I, 150K and 150L which is a singular form. Next, the hoop engaging protrusion 157t of the blade base 157 is inserted and assembled to the base pillar 156t of the hoop base 156 protruded in the outer direction of the hoop module 140 in case of each of the outer blades 150B, 150C, 150E, 150F, 150H, 150I, 150K and 150L. The engaging adaptor 155 is assembled to the blade base 157, and the inner engaging part 151 of each of the outer blade 150B, 150C, 150E, 150F, 150H, 150I, 150K and 150L is assembled and engaged to the thusly assembled engaging adaptor 155, thus assembling and engaging the outer blades 150B, 150C, 150E, 150F, 150H, 150I, 150K and 150L, which is a singular form, to the outer side of the hoop module 140.

Next, the assembling and engaging procedures of the inner blade module 120 and the control hub module 110 both positioned at the inner side of the hoop module 140 will be described. During the above procedures, when assembling and engaging, the link assembly part 131 of the link module 130 is inserted into the outer circumferential surface engaging part 123 of the inner blade module 120, and in a state that the link engaging part 131 is inserted, the outer circumferential surface engaging part 123 of the inner blade module 120 is inserted into the hoop hole 142h formed at each of hoop connector 142A to 142D of the hoop module 140, and the inner blades 120A to 120D forming the inner blade module 120 are gathered toward the center in a cross (+) shape. At this time, each of the inner blades 120A to 120D of the inner blade module 120 in a state that the engaging gear part 121 is not engaged yet. In terms of the portion in relation with the control hub module 110, four engaging gear parts 121 are inserted from the inner side into the outer side of the hub bracket 112, and the bracket cover 114 with the control motor 113 being inserted therein is engaged with the hub bracket 112 and is gear-engaged with the four engaging gear parts 121 inserted in the hub bracket 112, and then the hub bracket 112 is assembled and engaged to the hub base 111, thus almost forming the whole construction of the control hub module 110. The almost assembled control hub module 110 is positioned in the central direction of the hoop module 140 to which the wing part 122 and the outer circumferential surface engaging part 123 of the inner blade module 120 are assembled, and then each wing part 122 of the inner blade module 120 is assembled and engaged, by means of the four inner blades 120A to 120D, to the four engaging gear parts 121 assembled and engaged along with the control hub module 110, and then the hub cover 115 is covered, thus completing the assembling procedures of the control hub module 110 and the inner blade module 120 at the inner side of the hoop module 140.

In a state that the link assembly part 131 of the link module 130 is inserted in the outer circumferential surface engaging part 123 of the inner blade module 120, the inner blade module 120 is assembled and engaged to the hoop module 140, and the link module 130 might be engaged to the outer blades 150B, 150C, 150E, 150F, 150H, 150I, 150K and 150L which is a singular form. The assembling procedures of the same are not important, but the assembling and engaging procedures of the outer blades 150A, 150D, 150G and 150J of the outer blade module 150 assembled and engaged on the same extended line of the inner blade module 120 will be described. During the above procedures, it is preferred to be prepared like the mover 142r is inserted into each of the hoop hole 142h of the hoop module 140, and the inner blade module 120 and the outer blade module 150 are naturally movable while the hoop module 140 is maintaining an assembled shape. In the above state, the pin protrusion 155t is fixedly inserted into each of the outer circumferential surface engaging part 123 of the inner blade module 120, so the engaging adaptor 155 is engaged, and the protrusion pillar 155q of the engaged engaging adaptor 155 is inserted into an inner side of the inner engage part 151 of the outer blade module 150. In a state that the circumferential surface of the engaging circular disk 155p comes into contact with the circumferential surface of the inner engaging part 151, the engaging circular disk 155p of the engaging adaptor 155 and the inner engaging part 151 of the outer blade module 150 are engaged by way of the grooves formed at the circumferential surfaces of the engaging circular disk 155p, thus engaging the inner blade module 120 and the outer blade module 150. The hoop actiniform turbine blade is configured like the control hub module 110, the inner blade module 120 and the outer blade module 150 are assembled and engaged to the hoop module 140.

During the earlier mentioned engaging procedure, the link engaging assembly part 131 of the inserted link module 130 is assembled and engaged to the outer circumferential surface engaging part 123 of the inner blade module 120. In each of the outer blades 150B, 150C, 150E, 150F, 150H, 150I, 150K and 150L, a plurality of link assembly pats 131 are assembled and engaged to each of the protrusion portions in the outer side of the lower end portion of the hoop base 156 of the hoop module 140, and the link engaging assembly part 131 of the link module 130 inserted in the outer circumferential surface engaging part 123 are connected by way of the link bar 132, thus finishing the assembling and engaging procedures of the link module 130. In the assembled hoop actiniform turbine blade, the hub base 111 of the control hub module 110 is assemble and engaged to a front side of the Nacelle device 10Tn of the tower module 10T, so the turbine blade wind power generation system 10 of the present embodiment can be installed at a desired position.

In the normal case, a large rotation moment is needed for rotating the blades in an attempt to increase electric power generation capacity, and a large size blade diameter is needed accordingly. The wind power generation system 10 according to the present invention is directed to providing a structure which helps significantly increase the number of rotation blades in a stable way. The absorption efficiency of wind power can be increased unless the diameter of each blade is needed to be large, so efficient operations can be obtained at a low speed of wind. The pitch angles of the inner and outer blades are adjusted depending on the speed of wind, so stable operations can be conducted under various conditions of wind speed. The system of the present invention can be manufactured in a certain size depending on the demand and installation place of an organization such as home, school, company, etc.

In the present invention, the lengths of the inner and outer blade modules 120 and 150 can be elongated or shortened by changing the constructions and types depending on the earlier mentioned principles. It is possible to provide the outer blades of the outer blade module 150 in a desired number. In addition to the earlier described devices and systems, the present invention is directed to further installing various facilities for a user's or operator's convenience and controlling the same.

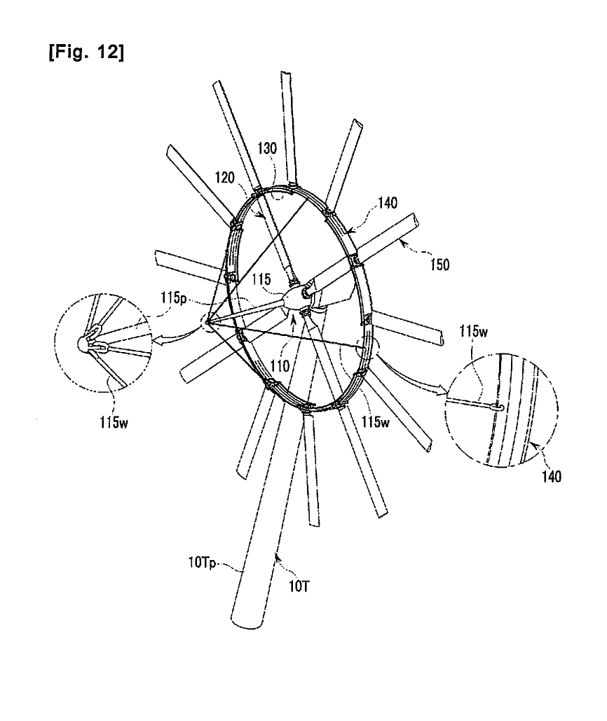

As shown in FIG. 12, the wind power generation system according to the present invention is basically directed to resolving the structural weakness the hoop module 140 to the control hub module 110 by way of a support means now that there is a structural weakness in the conventional art because the hoop module 140 is connected to an end portion of the inner blade module 120. In the present embodiment, a support protrusion 115p with a certain length is protruded from a front central portion of the hub cover 115 forming the control hub module 110, and there is provided a connection body 115w both ends of which are connected with the end portion of the support shaft 115p and the hoop module 140, respectively. As shown in the drawing, the connection body 115w is provided in multiple numbers in an actiniform shape and is formed of a wire, a rope, a steel rod, a steel cable, etc. It might be welded at the support shaft 115p and the hoop module 140 or might be connected by means of a known mechanical engaging structure.

As described above, the specific embodiments of the present invention have been described, but the present invention is not limited thereto. It is obvious that an ordinary person skilled in the art can modify the disclosures within a scope of the concept of the present invention, and such modifications belong to the scope of the present invention.

1. A wind power generating system using turbine blades radially arranged along a ring structure which is installed at a support structure at a certain height facing a lot of wind and rotates depending on the direction of wind, thus control-generating wind power depending on the speed of wind, comprising:
a control hub module which is extended in a forward direction of a central shaft of the support structure from the top of the support structure and is assembled and engaged and serves to control the pitch angles of a plurality of blades forming the wind power generation system depending on the speed of wind;
an inner blade module which causes rotations at a central portion by means of the wind blowing toward the inner side of the wind power generation system and in which an inner central portion is engaged with the control hub module so that it operates in accordance with a control of the control hub module, and is formed by a certain length in an equally divided actiniform shape from the center of the control hub module;
a link module of which one end is assembled and engaged to an end portion of the inner blade module, and the other end is assembled and engaged to the outer blade module, so that the pitch angles can rotate depending on the rotation operation of the inner blade module;
a hoop module which is formed in a circular hoop shape with a certain width in a state that the end portion of the inner blade module is fixed toward the outside of the inner blade module; and
an outer blade module which causes rotations by means of wind blowing toward the outside of the wind power generation system and is formed in an actiniform shape by a certain length toward the outside of the hoop module in a state that an end portion of each one side is engaged in an outward direction of the hoop module, whereby the pitch angles of the inner blade module and the outer blade module are control-rotated depending on the speed of wind, and the pitch angles based on the change of the speed of wind are adjusted, thus generating wind power.

2. A wind power generating system using turbine blades radially arranged along a ring structure according to claim 1, further comprising:
a tower module which is formed in a pillar shape in whole in the wind power generation system and serves to support the system while rotation-controlling depending on the direction of wind at a certain height.

3. A wind power generating system using turbine blades radially arranged along a ring structure according to claim 1, wherein said control hub module comprises:
a hub base which is formed in a circular disk shape to support and stand the force during the wind power generation by means of the wind coming in and the rotation control of the control hub module;
a hub bracket which is formed in a cylindrical shape in whole and has a bracket hole enabling the inner blades of the inner blade module to be engaged to a cylindrical circumferential surface in an inserted state;
a control motor in which gears are formed in its cross section direction coming into contact with the inner blades of the inner blade module and rotation-controls the pitch angles of the inner blade module in accordance with a control of the tower module;
a bracket cover which covers one side of the cylindrical hub bracket in a state that the end portions of the control motor are engaged with the end portions of the inner blades of the inserted inner blade module in a state that the control motor is inserted; and
a hub cover which is formed in a hollow cap shape in whole and has a U-shaped curved groove so that the inner blades of the inner blade module inserted and engaged to the hub bracket are interdigitated.

4. A wind power generating system using turbine blades radially arranged along a ring structure according to claim 1, wherein said inner blade module comprises:
a plurality of inner blades each comprising:
an engaging gear part which is inserted into the hub bracket of the control hub module and is assembled and engaged in a way to be engaged with the control motor of the control hub module;
a wing part which has a certain length and is formed in an aerodynamic wing shape and is engaged next to the engaging gear part; and
an outer circumferential surface engaging part which is formed in a circular pillar shape protruded by a certain length in an outward direction of the wing part and has an engaging hole for an engagement in an outward direction.

5. A wind power generating system using turbine blades radially arranged along a ring structure according to claim 1, wherein said link module comprises:
a link assembly part which is selectively engaged to between the inner blade module and the outer blade module, thus transferring a rotational driving force; and
a link bar which is formed in a stick-shaped longitudinal bar shape and is drivingly coupled with the link assembly part and is connected to transfer a rotational driving force from the link assembly part.

6. A wind power generating system using turbine blades radially arranged along a ring structure according to claim 1, wherein said hoop module comprises:
a plurality of partial hoop parts which have certain widths like a belt and are classified in an arc shape of a certain angle and have hoop holes for an installation in an actiniform structure; and
a plurality of hoop connector parts which help position the partial hoop at both sides and help couple the partial hoop between the same.

7. A wind power generating system using turbine blades radially arranged along a ring structure according to claim 1, wherein said hoop module has a certain width like a belt and is formed in a circular ring shape having one body for installing the outer blade module in an actiniform shape in a state that a plurality of regularly spaced-apart hoop holes are formed.

8. A wind power generating system using turbine blades radially arranged along a ring structure according to claim 6, wherein said hoop module is characterized in that a mover formed with its inner and outer sides being movable with respect to each other is inserted and assembled in the plurality of hoop holes so that the inner blade module and the outer blade module can naturally operate while the hoop module can maintain an assembled frame.

9. A wind power generating system using turbine blades radially arranged along a ring structure according to claim 8, wherein said mover is formed of a bearing.

10. A wind power generating system using turbine blades radially arranged along a ring structure according to claim 1, wherein said outer blade module comprises:
an inner engaging part which is formed in a cylindrical shape at a central portion protruded in the direction from the outer blade module to the hoop module and has an engaging end portion formed in a vertical direction while coming into contact with the cylindrical shape; and
a wing part which has a certain length in an aerodynamic wing shape and is engaged next to coming into contact with the inner engaging part.

11. A wind power generating system using turbine blades radially arranged along a ring structure according to claim 10, wherein said outer blade module is directed to assembling and engaging the outer blade module by selectively selecting at least one from the group consisting of:
an engaging adaptor which comprises a pin protrusion protruded from a cross section for inserting and engaging to the engaging hole formed at the inner blade module at one side about the disk shaped circular engaging disk at the center, and a circular pillar shaped protrusion pillar for inserting into the inner engaging part of the cylindrical outer blade module for preventing movement at the opposite side;
a hoop base which has a link engaging terminal formed by protruding in a pillar shape for inserting and engaging the link module at one side about the circular disk shaped hoop base circular disk for attaching to a surface of the hoop module at the center and a base pillar which is protruded in a circular pillar shape at the opposite side; and
a blade base which has a protrusion shaped hoop engaging protrusion from a cross section for inserting and engaging the hoop module at one side about the circular disk shaped blade base circular disk at the center, and a hoop engaging terminal protruded in a circular pillar shape for an engagement with the engaging adaptor at the other side.

12. A wind power generating system using turbine blades radially arranged along a ring structure according to claim 1, wherein said control hub module comprises:
a support shaft which is protruded in a forward direction and provides a support force as its both ends are connected to the support shaft and the hoop module, and said control hub module further comprising:
a connection body which is formed of a wire, rope, a steel rod or a steel cable.
